(19) United States
(12) Patent Application Publication
(10) Pub. No.: US 2014/0299396 A1
(43) Pub. Date: Oct. 9, 2014

(54) VEHICLE FRONT PORTION STRUCTURE

(71) Applicant: Masao Tajima, Toyota-shi (JP)

(72) Inventor: Masao Tajima, Toyota-shi (JP)

(73) Assignee: TOYOTA JIDOSHA KABUSHIKI KAISHA, Toyota-shi (JP)

(21) Appl. No.: 14/361,864

(22) PCT Filed: Dec. 16, 2011
(86) PCT No.: PCT/JP2011/079251

§ 371 Date: May 30, 2014

(51) Int. Cl. B60K 11/08

(52) U.S. Cl. CPC B60K 11/08
USPC 180/68.1

(57) ABSTRACT

To provide a vehicle front portion structure that can sufficiently ensure an amount of cooling wind that is introduced into a cooling unit disposed at a rear of a power unit. A vehicle front portion structure has: a power unit that is fixed to an interior of a power unit room; a cooling unit provided at a rear of the power unit; an undercover that adjusts a flow of air flowing through a lower portion of a vehicle; a cooling wind introducing hole that is provided in the undercover at a rear of the power unit and in front of the cooling unit; and a cooling wind introducing passage that blows out air, that has been introduced from a front side opening end portion, toward the cooling unit from a rear side opening end portion that is provided above the cooling wind introducing hole, at a flow velocity that is faster than a flow velocity of the air flowing through the lower portion of the vehicle.

### TECHNICAL FIELD

The present invention relates to a vehicle front portion structure that introduces cooling wind into a cooling unit that is disposed at the rear of a power unit.

### BACKGROUND ART

Structures, in which a radiator that serves as a cooling unit is disposed at the rear of a power unit, are known. (See, for example, WO/2010/097890.)

### DISCLOSURE OF INVENTION

### Technical Problem

However, in a structure in which a cooling unit is disposed at the rear of a power unit, there is room for improvement with respect to ensuring the introduced-in amount of cooling wind that is introduced into the cooling unit.

In view of the above-described circumstances, an object of the present invention is to obtain a vehicle front portion structure that can sufficiently ensure the amount of cooling wind that is introduced into a cooling unit that is disposed at the rear of a power unit.

### Solution to Problem

A vehicle front portion structure relating to a first aspect comprises: a power unit that is fixed to an interior of a power unit room provided at a front portion of a vehicle; a cooling unit provided at a rear of the power unit; an undercover that is provided below the power unit and the cooling unit, and that adjusts a flow of air flowing through a lower portion of the vehicle; a cooling wind introducing hole that is provided in the undercover at a rear of the power unit and in front of the cooling unit, and that introduces, into the cooling unit, the air flowing through the lower portion of the vehicle; and a cooling wind introducing passage that has a front side opening end portion introducing air from a front side of the vehicle, and that blows out air, that has been introduced from the front side opening end portion, toward the cooling unit from a rear side opening end portion that is provided above the cooling wind introducing hole, at a flow velocity that is faster than a flow velocity of the air flowing through the lower portion of the vehicle.

In accordance with the above-described aspect, the flow velocity of the air that is blown out from the rear side opening end portion of the cooling wind introducing passage, i.e., the flow velocity of the air that flows above the cooling wind introducing hole that is provided in the undercover, is faster than the flow velocity of the air that flows between the undercover and the road surface, i.e., the flow velocity of the air that flows beneath the cooling wind introducing hole. Accompanying this, the pressure of the air, that flows below of the cooling wind introducing hole is higher than the pressure of the air that flows above the cooling wind introducing hole. As a result, the air that flows between the undercover and the road surface is introduced from the cooling wind introducing hole toward the cooling unit. In other words, the air that flows between the undercover and the road surface is pulled in from the cooling wind introducing hole by the air that flows at the upper side of the cooling wind introducing hole.

In a vehicle front portion structure relating to a second aspect, in the above-described first aspect, an opening surface area of the front side opening end portion is set to be greater than an opening surface area of the rear side opening end portion.

In accordance with the above-described aspect, the opening surface area of the front side opening end portion is set to be greater than the opening surface area of the rear side opening end portion. Therefore, due to the so-called Venturi effect, the flow velocity of the air that is blown out from the rear side opening end portion, becomes higher than the flow velocity of the air that flows from the front side opening end portion. As a result, when the vehicle travels, air that flows between the undercover and the road surface is introduced from the cooling wind introducing hole toward the cooling unit, even if an electric fan or the like is not operated or if the output of the electric fan is kept low.

In a vehicle front portion structure relating to a third aspect, in the above-described first aspect or second aspect, a length of a flow path of the cooling wind introducing passage is set to be longer than a distance, in a vehicle longitudinal direction, between the front side opening end portion and the rear side opening end portion of the cooling wind introducing passage.

In accordance with the above-described aspect, the length of the cooling wind introducing passage is set to be as described above. Therefore, the flow velocity of the air, that flows through the interior (the flow path) of the cooling wind introducing passage becomes higher than the flow velocity of the air that flows below the cooling wind introducing passage (between the undercover and the road surface). As a result, when the vehicle travels, air that flows between the undercover and the road surface is introduced from the cooling wind introducing hole toward the cooling unit, even if an electric fan or the like is not operated or if the output of the electric fan is kept low.

In a vehicle front portion structure relating to a fourth aspect, in any one aspect of the above-described first aspect through third aspect, a flap, having a surface that is directed toward a front side of the vehicle, is provided at an end portion at a vehicle rear side of a peripheral edge portion of the cooling wind introducing hole.

In accordance with the above-described aspect, when the air, that flows between the undercover and the road surface, decelerates as a result of hitting the flap, the pressure of the air that flows below the cooling wind introducing hole rises. Namely, the difference between the pressure of the air that flows below the cooling wind introducing hole, and the pressure of the air that flows above the cooling wind introducing hole, becomes even greater. As a result, an even greater amount of air is introduced from the cooling wind introducing hole toward the cooling unit.

In a vehicle front portion structure relating to a fifth aspect, in any one aspect of the above-described first aspect through fourth aspect, a portion of the cooling wind introducing passage is formed so as to extend-out toward a vehicle rear side, and the portion that is formed so as to extend-out and the cooling wind introducing hole are disposed so as to overlap in a vertical direction of the vehicle.

In accordance with the above-described aspect, even if foreign matter, such as grit or stones or the like, attempts to enter in from the cooling wind introducing hole toward the cooling unit, this foreign mater hits a portion of the cooling wind introducing passage, and thereafter, is bounced-back toward the lower side of the vehicle. In other words, foreign matter, such as grit or stones or the like, entering in from the cooling wind introducing hole toward the cooling unit is suppressed by the portion of the cooling wind introducing passage.

In a vehicle front portion structure relating to a sixth aspect, in any one aspect of the above-described first aspect through fifth aspect, the cooling wind introducing passage is formed integrally with the undercover.

In accordance with the above-described aspect, the cooling wind introducing passage, that extends along the vehicle longitudinal direction, is formed integrally with the undercover. Therefore, this cooling wind introducing passage becomes a reinforcing portion of the undercover, and, accompanying this, the rigidity of the undercover improves.

### Advantageous Effects of Invention

As described above, the vehicle front portion structure relating to the first aspect has the excellent effect of being able to sufficiently ensure the amount of cooling wind that is introduced into a cooling unit that is disposed at the rear of a power unit.

The vehicle front portion structures relating to the second aspect and the third aspect have the excellent effect of being able to curb the amount of electric power that is consumed by an electric fan.

The vehicle front portion structure relating to the fourth aspect has the excellent effect of being able to further increase the amount of cooling wind that is introduced into the cooling unit.

The vehicle front portion structure relating to the fifth aspect has the excellent effect of being able to suppress damage to the cooling unit due to entry of foreign matter.

The vehicle front portion structure relating to the sixth aspect of the present invention has the excellent effect of being able to improve the rigidity of the undercover.

### BRIEF DESCRIPTION OF DRAWINGS

FIG. 1 is a cross-sectional view that shows a front portion of a vehicle to which a vehicle front portion structure of the present embodiment is applied, and that is seen from a side of the vehicle.

FIG. 2 is a perspective view showing the structure of an undercover.

FIG. 3 is an enlarged sectional view that shows a vicinity of a cooling wind introducing hole provided in the undercover, and that is seen from a side of the vehicle.

### BEST MODES FOR CARRYING OUT THE INVENTION

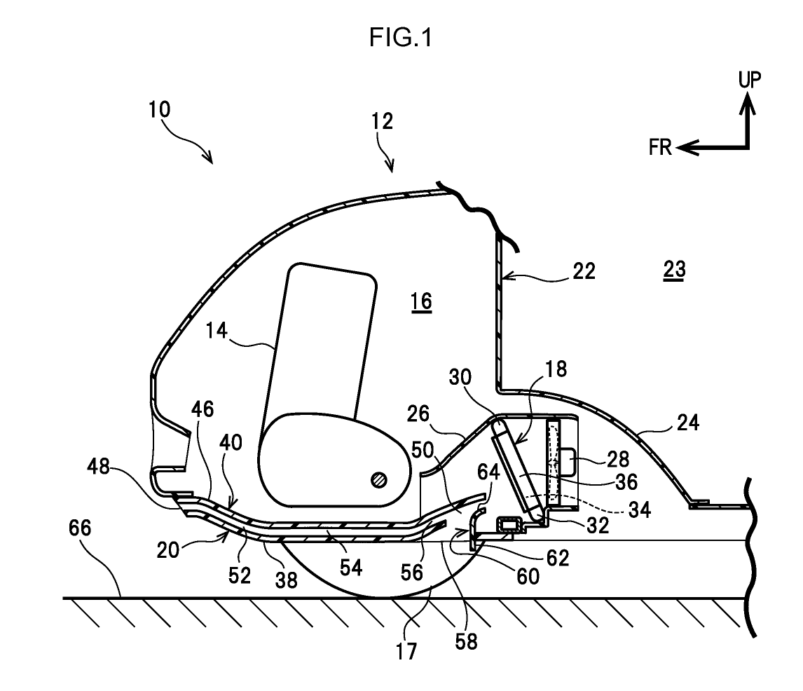

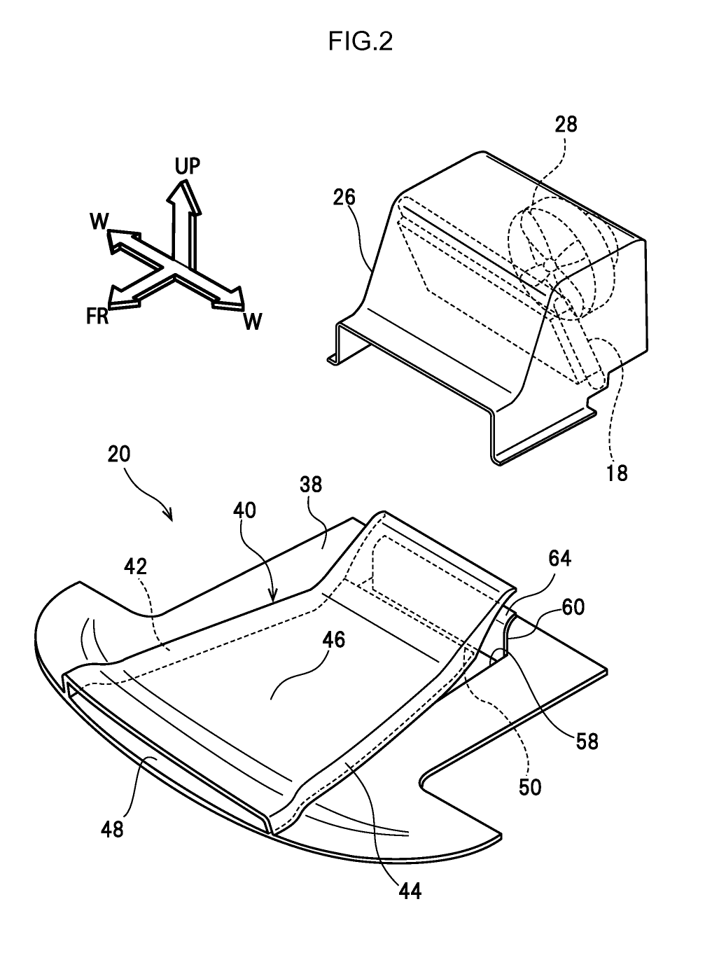

A vehicle front portion structure relating to an embodiment of the present invention is described by using FIG. 1 and FIG. 2. Note that arrow FR that is shown appropriately in the drawings indicates the frontward direction in the vehicle longitudinal direction, arrow UP indicates the upward direction in the vehicle vertical direction, and arrow W indicates the vehicle transverse direction, respectively. In the following description, when longitudinal and vertical directions are used, they mean the longitudinal of the vehicle longitudinal direction and the vertical of the vehicle vertical direction unless otherwise stated.

As shown in FIG. 1, a power unit room 16 in which a power unit 14 is accommodated is provided at the front portion of a vehicle 12 to which a vehicle front portion structure 10 of the present embodiment is applied. Further, a radiator 18, that serves as a cooling unit that cools an engine that structures the power unit 14, is provided at the rear of the power unit 14 in this power unit room 16. Moreover, an undercover 20, that extends in the vehicle longitudinal direction and the vehicle transverse direction, is provided at the lower side of the power unit 14 and the radiator 18. Hereinafter, the power unit room 16 is described first, and then the power unit 14, the radiator 18 and the undercover 20 are described.

(Power Unit Room 16)

The power unit room 16 is provided at the front portion of the vehicle 12 between unillustrated wheel houses in which left and right front tires 17 are accommodated. The power unit 14 and the radiator 18 that are described later, and in addition, a battery and the like that are not illustrated, are accommodated in this power unit room 16. Further, the power unit room 16 has a dash panel 22 that forms the rear wall of the power unit room 16, and suspension towers and aprons that form the side walls of the power unit room 16 and form the aforementioned wheel houses. Further, a pair of front side members, that are not illustrated and that are disposed so as to be adjacent to the suspension towers and the aprons, are provided within the power unit room 16. Moreover, unillustrated power unit mounts are mounted to the front side members.

Further, the undercover 20 that is described later is mounted to an opening portion formed at the vehicle lower side of the power unit room 16, so as to close-up this opening portion. Further, due to an opening portion, that is formed at the vehicle upper side of the power unit room 16, being closed by a hood, the power unit room 16 and the outer side of the power unit room 16 are partitioned so as to be able to be opened and closed.

(Power Unit 14)

The power unit 14 is structured to include an engine that is a so-called internal combustion engine, and a transmission that transmits motive power generated by this engine. The engine is structured to include numerous parts such as pistons, cylinders, a crank shaft, and the like, and converts thermal energy, that is generated by fuel such as gasoline or the like burning within the cylinders, into energy of motion (rotational motion of the crank shaft). Further, the transmission that is used in the present embodiment is a continuously variable transmission (a so-called “CVT”) that is structured to include a metal belt and pulleys. The needed number of rotations and motive power of the rotational force are brought forth from the output shaft of this continuously variable transmission due to the number of rotations of the crank shaft, that is the output shaft of the above-described engine, being decelerated or accelerated to the needed number of rotations by this continuously variable transmission.

Moreover, the power unit 14, that is structured to include this engine and continuously variable transmission, is fixed to the power unit room 16 interior via the power unit mounts that are provided at the aforementioned front side members.

(Radiator 18)

The radiator 18 is a part that is plate-shaped and is formed in an elongated shape in the vehicle transverse direction, and has the function of cooling the engine that structures the power unit 14. This radiator 18 is disposed at the rear of the power unit 14, and is provided at the front of the dash panel 22 that is disposed at the rear side of the power unit room 16. To describe in further detail, a bulging portion 24, that is formed so as to protrude-out toward a cabin 23, is provided at the dash panel 22, and the radiator 18 is disposed in front of the dash panel 22 and beneath this bulging portion 24. Further, the radiator 18 is fixed in a state in which the upper end portion thereof is inclined toward the vehicle front side. Note that, around the radiator 18, a shroud 26 that guides air that flows toward the radiator 18 is provided, and an electric fan 28 is provided at the rear surface of the radiator 18.

Further, the radiator 18 has an upper tank 30, a lower tank 32, and an unillustrated connecting pipe that connects this upper tank 30 and lower tank 32. Fins 34 are mounted around this connecting pipe, and a radiator core 36, that is the cooling portion of the radiator 18 and whose main elements are this connecting pipe and the fins 34, is formed.

Moreover, the upper tank 30 of the radiator 18 is connected, via an unillustrated pipe, to a cooling water output port that is provided at the engine, and the lower tank 32 of the radiator 18 is connected, via an unillustrated pipe, to a cooling water introducing port provided at the engine. Moreover, cooling water is filled into an unillustrated water jacket that is formed at the radiator 18, the pipes that connect the radiator 18 and the engine, and the engine interior.

(Undercover 20)

As shown in FIG. 2, the undercover 20 is a large resin-molded part that extends in the vehicle longitudinal direction and the vehicle transverse direction, and has the function of adjusting the flow of air that flows at the lower portion of the vehicle 12. Concretely, the undercover 20 has a general portion 38 that extends in the vehicle longitudinal direction and the vehicle transverse direction. This general portion 38 is formed so as to avoid the front tires 17 (see FIG. 1), and the end portion thereof at the vehicle front side is formed along the shape of the front bumper.

Further, a cooling wind introducing passage 40 that extends along the vehicle longitudinal direction is provided at the intermediate portion in the vehicle transverse direction of the undercover 20. This cooling wind introducing passage 40 has a right side vertical wall portion 42 and a left side vertical wall portion 44 that extend toward the vehicle upper side from the end surface at the vehicle upper side of the general portion 38, and has a top wall portion 46 that connects this right side vertical wall portion 42 and left side vertical wall portion 44 in the vehicle transverse direction. As a result, the flow path of the cooling wind introducing passage 40 is made to be a closed cross-section that is substantially rectangular as seen in a vehicle front view.

Moreover, the front end portion of the cooling wind introducing passage 40 is made to be a front side opening end portion 48 that takes-in air from the front side of the vehicle 12, and the rear end portion is made to be a rear side opening end portion 50 that blows-out, toward the radiator 18, air that is taken-in from the front side opening end portion 48. Further, the cooling wind introducing passage 40 is formed so as to become more narrow from the vehicle front toward the rear as seen in plan view. As a result, the opening surface area of the front side opening end portion 48 is greater than the opening surface area of the rear side opening end portion 50, and the flow path of the cooling wind introducing passage 40 gradually becomes narrow from the vehicle front toward the rear.

Further, as shown in FIG. 1, the cooling wind introducing passage 40 has a first flow path 52 that extends at an incline toward the lower side from the front side opening end portion 48 toward vehicle rear side, a second flow path 54 that is bent from the rear end portion of this first flow path and extends toward the vehicle rear side, and a third flow path 56 that extends at an incline toward the upper side from the rear end portion of this second flow path 54 toward the vehicle rear side. Namely, the length of the flow path of the cooling wind introducing passage 40 from the front side opening end portion 48 to the rear side opening end portion 50 is set to be longer than the distance, in the vehicle longitudinal direction, between this front side opening end portion 48 and rear side opening end portion 50. Further, the rear end portion of the third flow path 56 is formed such that the top wall portion 46 extends-out further toward the vehicle rear side than the general portion 38.

Further, a cooling wind introducing hole 58, that is substantially rectangular in plan view and opens in the vehicle vertical direction, is formed in the general portion 38 of the undercover 20 at the rear of the power unit 14 and in front of the radiator 18. Moreover, this cooling wind introducing hole 58 is disposed so as to overlap, in the vehicle vertical direction, the top wall portion 46 that serves as a portion of the above-described cooling wind introducing passage 40.

Moreover, a flap 60, that is plate-shaped and whose surface is directed toward the vehicle front side, is provided at the end portion at the vehicle rear side of the cooling wind introducing hole 58. This flap 60 is fixed in a state in which a lower end portion 62 of the flap 60 projects-out toward the vehicle lower side from the general portion 38 of the undercover 20. Further, an upper end portion 64 of this flap 60 is formed so as to bend toward the radiator 18.

The operation and the effects of the present embodiment are described next.

As shown in FIG. 1, when the engine, that structures the power unit 14 that is fixed to the power unit room 16 interior, is started, simultaneously with the operation of the engine, an unillustrated water pump that is mounted to the engine operates. Accompanying the operation of this water pump, the cooling water that has been warmed at the interior of the engine is sent under pressure to the upper tank 30 of the radiator 18 via a pipe. Further, the cooling water, that is sent under pressure to the upper tank 30, passes through the connecting pipe and flows to the lower tank 32. Due to the cooling water, that flows through the interior of this connecting pipe, being cooled by the air that comes out from between the fins 34, the heat of the engine interior is dissipated from the radiator core 36. Moreover, the cooling water that has flowed to the lower tank 32 flows via a pipe toward the cooling water introducing port that is formed at the engine. Further, the cooling water, that is introduced into the engine interior from this cooling water introducing port, is again sent under pressure from the cooling water output port to the upper tank of the radiator 18 by the water pump. In this way, the engine is cooled due to cooling water circulating between the engine and the radiator 18.

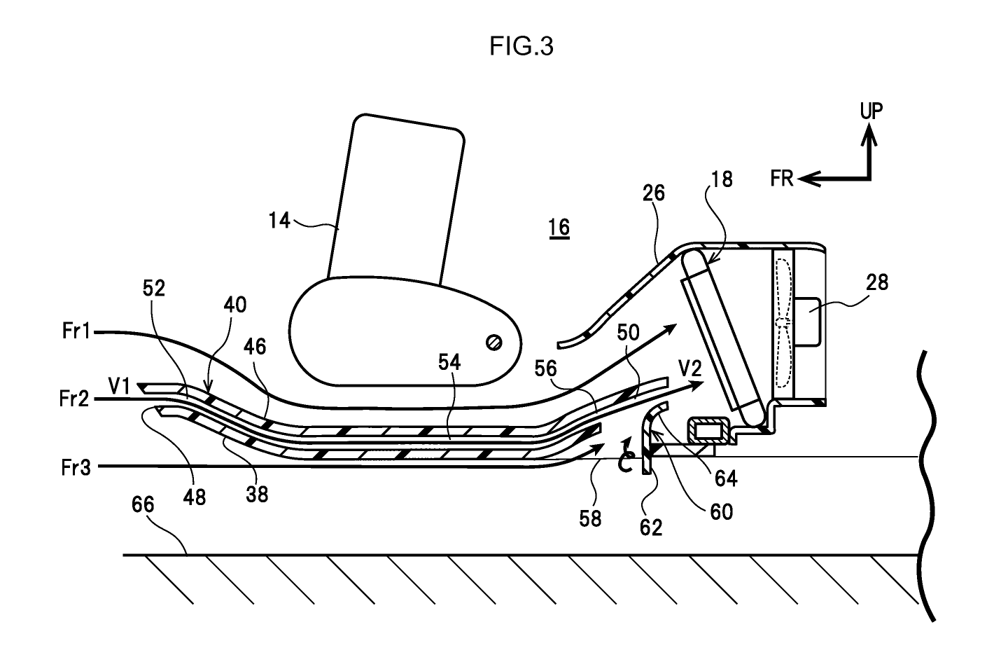

Further, accompanying the traveling of the vehicle 12, air flows around the vehicle 12 from the front toward the rear. Concretely, as shown in FIG. 3, air Fr1, that has flowed into the power unit room 16 from the front end portion of the vehicle 12, passes beneath the power unit 14, and thereafter, flows toward the front of the radiator 18. Further, air Fr2, that has flowed-in from the front side opening end portion 48 of the cooling wind introducing passage 40 provided at the undercover 20, passes through the first flow path 52, the second flow path 54 and the third flow path 56, and thereafter, is blown out toward the radiator 18 from the rear side opening end portion 50. Here, in the present embodiment, the opening surface area of the front side opening end portion 48 is set to be greater than the opening surface area of the rear side opening end portion. Therefore, due to the so-called Venturi effect, flow velocity V2 of the air, that is blown out from the rear side opening end portion 50, rises to more than flow velocity V1 of the air that flows in from the front side opening end portion 48. Further, air Fr3, that flows between the undercover 20 and a road surface 66, flows as substantially the same velocity as the flow velocity V1 of the air Fr2 that flows from the front side opening end portion 48 of the above-described cooling wind introducing passage 40, and a portion of this air Fr3 decelerates due to hitting the lower end portion 62 of the flap 60.

As described above, in the present embodiment, the flow velocity V2 of the air Fr2 that is blown out from the rear side opening end portion 50 of the cooling wind introducing passage 40 (i.e., the flow velocity V2 of the air Fr2 that flows above the cooling wind introducing hole 58 that is provided in the undercover 20), is faster than the flow velocity V1 of the air Fr3 that flows between the undercover 20 and the road surface 66 (i.e., the flow velocity V1 of the air Fr3 that flows beneath the cooling wind introducing hole 58). Accompanying this, the pressure of the air Fr3, that flows through the lower side of the cooling wind introducing hole 58, is higher than the pressure of the air Fr2 that flows at the upper side of this cooling wind introducing hole 58. As a result, the air Fr3, that flows through the lower side of the cooling wind introducing hole 58, is introduced in from the cooling wind introducing hole 58 toward the radiator 18. In other words, the air Fr3, that flows through the lower side of the cooling wind introducing hole 58, is pulled-in from the cooling wind introducing hole 58 by the air Fr2 that flows through the upper side of the cooling wind introducing hole 58. Accordingly, in the present embodiment, the amount of cooling wind, that is introduced into the radiator 18 that is disposed at the rear of the power unit 14, can be ensured sufficiently.

Further, in the present embodiment, the opening surface area of the front side opening end portion 48 is set to be greater than the opening surface area of the rear side opening end portion 50. Moreover, in the present embodiment, the length of the flow path of the cooling wind introducing passage 40 from the front side opening end portion 48 to the rear side opening end portion 50 is set to be longer than the distance, in the vehicle longitudinal direction, between this front side opening end portion 48 and rear side opening end portion 50. Therefore, when the vehicle travels, it is possible to make the flow velocity V2 of the air Fr2, that is blown out from the rear side opening end portion 50, faster than the flow velocity V1 of the air that is introduced from the front side opening end portion 48, even if the electric fan 28 is not operated or the output of the electric fan 28 is kept low. Namely, in the present embodiment, the amount of electric power consumed by the electric fan 28 can be curbed.

Moreover, in the present embodiment, when the air Fr3, that flows between the undercover 20 and the road surface 66, decelerates due to hitting the flap 60, the pressure of the air Fr3, that flows at the lower side of the cooling wind introducing hole 58, rises. Namely, the difference between the pressure of the air Fr3, that flows through the lower side of the cooling wind introducing hole 58, and the pressure of the air Fr2, that flows at the upper side of the cooling wind introducing hole 58, becomes even greater. As a result, in the present embodiment, an even greater amount of air can be introduced from the cooling wind introducing hole 58 toward the radiator 18.

Further, in the present embodiment, even if foreign matter, such as grit or stones or the like, attempts to enter in from the cooling wind introducing hole 58 toward the radiator 18, this foreign mater hits the top wall portion 46 of the third flow path 56 that is a portion of the cooling wind introducing passage 40, and thereafter, is bounced-back toward the lower side of the vehicle 12. In other words, foreign matter, such as grit or stones or the like, entering in from the cooling wind introducing hole 58 toward the radiator 18 is suppressed by the top wall portion 46 of the third flow path 56. Namely, in the present embodiment, damage to the radiator 18 due to entry of foreign matter can be suppressed.

Moreover, in the present embodiment, the cooling wind introducing passage 40, that extends along the vehicle longitudinal direction, is formed integrally with the undercover 20. Therefore, this cooling wind introducing passage 40 becomes a reinforcing portion of the undercover 20, and accompanying this, the rigidity of the undercover 20 improves. As a result thereof, the durability of the undercover 20 in cases in which the undercover 20 interferes with the road surface 66 improves, and sagging of the undercover 20 due to changes over time can be suppressed.

Note that the present embodiment describes an example in which the flow velocity V2 of the air, that is blown out from the rear side opening end portion 50, is raised to more than the flow velocity V1 of the air, that flows from the front side opening end portion 48, by setting the opening surface area of the front side opening end portion 48 of the cooling wind introducing passage 40 to be greater than the opening surface area of the rear side opening end portion 50. However, the present invention is not limited to this structure, and may be applied to another structure that can raise the flow velocity V2 of the air, that is blown out from the rear side opening end portion 50 of the cooling wind introducing passage 40, to more than the flow velocity V1 of the air that flows from the front side opening end portion 48.

Further, although the present embodiment describes an example in which the flap 60 is provided, there may be a structure in which this flap 60 is not provided. Whether or not to provide the flap 60 in this way can be set appropriately in consideration of the flow rate of the cooling wind that is introduced-in from the cooling wind introducing hole 58, and the road clearance (the distance between the undercover 20 and the road surface 66), and the like.

Moreover, the present embodiment describes an example in which foreign matter, such as grit or stones or the like, entering in from the cooling wind introducing hole 58 toward the radiator 18 is suppressed due to the top wall portion 46 of the third flow path 56, that is a portion of the cooling wind introducing passage 40, and the cooling wind introducing hole 58 being disposed so as to overlap in the vehicle vertical direction. However, the present invention is not limited to this, and may be structured such that foreign matter, such as grit or stones or the like, entering in from the cooling wind introducing hole 58 toward the radiator 18 is suppressed due to, for example, the cooling wind introducing hole 58 being covered by a lattice-shaped mesh sheet.

Further, although the present embodiment describes an example in which the cooling wind introducing passage 40 and the undercover 20 are formed integrally, the present invention is not limited to this and may be structured such that each is provided as a separate body.

Moreover, the present embodiment describes an example in which the radiator 18 that serves as the cooling unit is disposed at the rear of the power unit 14. However, the present invention is not limited to this, and may be structured such that another cooling unit is disposed at the rear of the power unit 14. For example, the condenser of an air conditioner, or an oil cooler that cools engine oil and the like, can be disposed as the cooling unit at the rear of the power unit 14.

Further, the present embodiment describes an example in which a CVT is used as the transmission of the power unit 14, but the present invention is not limited to this and may be a structure that uses an automatic transmission (AT) or a manual transmission (MT) or the like.

In addition, the present invention is not limited to the structure of the above-described embodiment, and it goes without saying that the present invention can be implemented by being modified in various ways within a scope that does not deviate from the gist thereof.

1. A vehicle front portion structure comprising:
a power unit that is fixed to an interior of a power unit room provided at a front portion of a vehicle;
a cooling unit provided at a rear of the power unit;
a shroud that guides air flowing toward the cooling unit;
an undercover that is provided below the power unit and the cooling unit, and that adjusts a flow of air flowing through a lower portion of the vehicle;
a cooling wind introducing hole that is provided in the undercover at a rear of the power unit and in front of the cooling unit, and that introduces, into the cooling unit, the air flowing through the lower portion of the vehicle; and
a cooling wind introducing passage that has a front side opening end portion introducing air from a front side of the vehicle, and that blows out air, that has been introduced from the front side opening end portion, toward the cooling unit from a rear side opening end portion that is provided above the cooling wind introducing hole, at a flow velocity that is faster than a flow velocity of the air flowing through the lower portion of the vehicle,
wherein a portion of the cooling wind introducing passage is formed so as to extend-out toward a vehicle rear side, and the portion that is formed so as to extend-out is disposed between the shroud and the cooling wind introducing hole and so as to overlap the cooling wind introducing hole in a vertical direction of the vehicle.

2. The vehicle front portion structure of claim 1, wherein an opening surface area of the front side opening end portion is set to be greater than an opening surface area of the rear side opening end portion.

3. The vehicle front portion structure of claim 1, wherein a length of a flow path of the cooling wind introducing passage is set to be longer than a distance, in a vehicle longitudinal direction, between the front side opening end portion and the rear side opening end portion of the cooling wind introducing passage.

4. (canceled)

5. (canceled)

6. The vehicle front portion structure of claim 1, wherein the cooling wind introducing passage is formed integrally with the undercover.

7. A vehicle front portion structure comprising:
a power unit that is fixed to an interior of a power unit room provided at a front portion of a vehicle;
a cooling unit provided at a rear of the power unit;
an undercover that is provided below the power unit and the cooling unit, and that has a general portion extending in a vehicle longitudinal direction and a vehicle transverse direction, and that adjusts a flow of air flowing at a lower portion of the vehicle;
a cooling wind introducing hole that is provided in the undercover at a rear of the power unit and in front of the cooling unit, and that introduces, into the cooling unit, the air flowing through the lower portion of the vehicle;
a cooling wind introducing passage that has a front side opening end portion introducing air from a front side of the vehicle, and that blows out air, that has been introduced from the front side opening end portion, toward the cooling unit from a rear side opening end portion that is provided above the cooling wind introducing hole, at a flow velocity that is faster than a flow velocity of air that flows at the lower portion of the vehicle; and
a flap whose surface is directed toward a front side of the vehicle, and that is fixed in a state of projecting-out toward a vehicle lower side from the general portion at an end portion at a vehicle rear side of a peripheral edge portion of the cooling wind introducing hole.

8. The vehicle front portion structure of claim 7, wherein an opening surface area of the front side opening end portion is set to be greater than an opening surface area of the rear side opening end portion.

9. The vehicle front portion structure of claim 7, wherein a length of a flow path of the cooling wind introducing passage is set to be longer than a distance, in a vehicle longitudinal direction, between the front side opening end portion and the rear side opening end portion of the cooling wind introducing passage.

10. The vehicle front portion structure of claim 7, wherein the cooling wind introducing passage is formed integrally with the undercover.
